(19) United States
(12) Patent Application Publication
(10) Pub. No.: US 2025/0118503 A1
(43) Pub. Date: Apr. 10, 2025

(54) CONTACTOR WITH ARC GUIDES AND PROTECTION INTEGRATED INTO THE ARC GUIDES, CORRESPONDING SYSTEM AND AIRCRAFT

(71) Applicant: SAFRAN ELECTRICAL & POWER, Blagnac (FR)

(72) Inventors: Guillaume PRIEUR, Moissy-Cramayel (FR); Cecil BELTAN, Moissy-Cramayel (FR); Kévin ENOUF, Moissy-Cramayel (FR)

(73) Assignee: SAFRAN ELECTRICAL & POWER, Blagnac (FR)

(21) Appl. No.: 18/729,399

(22) PCT Filed: Jan. 12, 2023
(86) PCT No.: PCT/FR2023/050042

§ 371 Date: Jul. 16, 2024

(30) Foreign Application Priority Data
Jan. 18, 2022 (FR) FR2200412

(51) Int. Cl. H01H 9/10; B64D 47/00; H01H 9/38

(52) U.S. Cl. CPC H01H 9/10; B64D 47/00; H01H 9/38; B64D 2221/00

(57) ABSTRACT

A contactor including a first electrical contact, a second electrical contact, and a movable bridge displaceable between a closed position and an open position, the contactor further including: a lower arc guide including a first portion connected to the first electrical contact, and a second portion connected to the second electrical contact, an upper arc guide including a first portion facing the first portion of the lower arc guide, a second portion facing the second portion of the lower arc guide, and a fuse connecting the first portion and the second portion of the upper arc guide.

### CROSS-REFERENCE TO RELATED APPLICATIONS

This is a National Stage Application under 35 U.S.C. § 371 of International Application No. PCT/FR2023/050042, filed Jan. 12, 2023, now published as WO 2023/139325 A1, which claims priority to French Patent Application No. 2200412, filed on Jan. 18, 2022.

### TECHNICAL FIELD

The invention relates to the general field of electrical energy distribution, in particular on aircraft. It specifically relates to contactors used in the electrical energy distribution systems of aircraft.

### PRIOR ART

In an aircraft, an electrical energy distribution system of HVDC (High Voltage Direct Current) type is used. The supply of power to the electrical loads by electrical sources is not generally done directly, since contactors are used to control this power supply or to switch the power in the distribution system.

A typical assembly includes the HVDC source, a distribution box, cables for connecting the source to the distribution box, and an electrical load connected to the distribution box. In the distribution box, on each phase, a contactor is arranged in series to form the interface between the electrical sources and the electrical load or loads.

It is recalled that a contactor generally includes two electrical contacts and a movable bridge displaceable between a so-called closed position in which the movable bridge is in contact with the first electrical contact and the second electrical contact, and a so-called open position in which the movable bridge is spaced apart from the first electrical contact and from the second electrical contact.

From the prior art contactors are known, described in the documents EP 1388154 and EP 2278599.

As will be seen with reference to FIGS. 1 to 5, upon the opening of the movable bridge, electrical arcs appear.

FIG. 1 is a schematic section view of a contactor 10 of the prior art. This contactor includes a first electrical contact 11A, a second electrical contact 11B, and a movable bridge 12.

On the figure, the movable bridge 12 is in the closed position. Its inner face F1 is in contact with the two electrical contacts 11A and 11B, at the contact interfaces IC. Hence, the electrical current can flow through the contactor from the first contact 11A to the second contact 11B through the movable bridge 12. The flow of the current is represented by bold arrows on the figure.

Note that the contactor also includes a lower arc guide, comprising a first portion 13A connected to the first electrical contact 11A, which extends in the opposite direction to the second electrical contact with respect to the first electrical contact. The lower arc guide further comprises a second portion 13B connected to the second electrical contact 11B, which extends in the opposite direction to the first electrical contact with respect to the second electrical contact. The lower arc guide extends in the lower portion of the contactor, delimited by the movable bridge (on the figure, below the movable bridge, the lower portion is shown, and above the movable bridge, the upper portion is shown).

On the side of the upper face F2 of the movable bridge, which is opposite the face F1, in the upper portion of the contactor, an upper arc guide 14 is arranged.

At the lateral ends of the contactor, between the upper arc guide and the lower arc guide, arc-breaking fins 15 are arranged.

The lower arc guide and the upper arc guide have a shape configured so that the space between these arc guides increases the further one moves from the electrical contacts (for example this space increases from the first electrical contact 11A in the direction opposite the second electrical contact 11B, and this space increases from the second electrical contact 11B in the opposite direction to the first electrical contact 11A).

Moreover, although this is not shown on the figure, the contactor includes permanent magnets generating a magnetic field \vec{B}, whose direction into the plane of the figure is symbolized by a circled cross.

There will now follow a description of the appearance of the electrical arcs and the operation of the arc guides of the contactor of the prior art with reference to FIG. 1.

FIG. 2 shows the separation of the contacts between the movable bridge 12 and the first electrical contact 11A on the one hand, and the movable bridge 12 and the second electrical contact 11B on the other hand. At the open interface IO between the movable bridge and the first electrical contact 11A, a first electrical arc AA, and, simultaneously, at the open interface IO between the movable bridge and the second electrical contact 11B, a second electrical arc AB form. The two electrical arcs AA and AB are formed by ionization of the air at the open interfaces IO. Thus, a current continues to flow through the contactor.

FIG. 2 also shows a magnification of the interface between the upper arc guide 14 and the movable bridge 12. These two elements are not intended to be in contact in the so-called open position.

FIG. 3 shows, not long after the opening shown on FIG. 2, the displacement on either side of the movable bridge of the arcs AA and AB. More precisely, the arc AA moves toward the left side of the figure, and the arc AB moves to the right-hand side on the figure. These two displacements result from the presence of the magnetic field \vec{B} and its effect on the Laplace force (denoted \vec{F}_{Laplace} on the figure). As can be seen on the figure, the shape of the arc guides extends the electrical arcs AA and AB, which can promote their breaking.

FIG. 4 shows the electrical arcs continuing to move toward the sides, not long after their displacement shown in FIG. 3. On this figure, it is also possible to observe the deformation of the arcs which then lick against the arc guides. Also, at this stage the current still flows through the movable bridge.

Subsequently and as shown on FIG. 5, the current ceases to follow the path passing through the electrical arcs licking against the arc guides and the bridge, in the upper portion, to pass entirely through the upper arc guide 14. In the lower portion, the current passes partly through the two lower arc guide portions 13A and 13B.

The electrical arcs AA and AB can be maintained indefinitely, but it is generally desirable to break them in 3 milliseconds. In fact, beyond 30 milliseconds, an electrical arc can damage the inside of the contactor.

If the current crossing the contactor has an excessively high amperage, the fins 15 may not be suitable for breaking the arcs AA and AB, which will stagnate in or in front of these fins.

As a reminder, these electrical arcs are plasmas of several thousand degrees, which, if they are maintained too long, may damage the contactor or even propagate beyond the contactor.

There is therefore a need for a solution that avoids this damage.

Since arcs are particularly problematic for high-amperage currents, it is possible to use fuses in series with the contactors intended to melt when these high amperage currents appear (typically when a short circuit appears).

For this purpose, the fuses used in HDVC systems in the automotive field, or else so-called pyrofuse devices are known.

While the addition of a fuse or a pyrofuse in series with the contactor might work, this solution has the drawback of requiring components which are cumbersome, heavy, and difficult to integrate around the contactors.

The invention aims in particular to remedy these drawbacks.

### SUMMARY OF THE INVENTION

For this purpose, the invention makes provision for a contactor intended to be used in an electrical power distribution system within an aircraft and including a first electrical contact, a second electrical contact, and a movable bridge displaceable between a so-called closed position in which the movable bridge is in contact with the first electrical contact and the second electrical contact, and a so-called open position in which the movable bridge is spaced apart from the first electrical contact and from the second electrical contact, the movable bridge having a first face intended to be in contact with the first electrical contact and the second electrical contact in the closed position, and a second face opposite the first face,

the contactor further comprising:
a lower arc guide comprising a first portion connected to the first electrical contact, extending in the opposite direction to the second electrical contact with respect to the first electrical contact, and a second portion connected to the second electrical contact, extending in the direction opposite the first electrical contact with respect to the second electrical contact,
an upper arc guide located on the side of the second face of the movable bridge and comprising a first portion facing the first portion of the lower arc guide, a second portion facing the second portion of the lower arc guide, and a fuse connecting the first portion and the second portion of the upper arc guide.

The term “facing” should be understood to mean that an electrical arc can be formed between these two portions, even if they are inclined with respect to one another.

Thus, the invention makes provision for using a fuse directly inside the contactor, to break the passage of the current when a passage of current occurs at the upper arc guide. In this scenario, which appears after an opening of the movable bridge, for a given time period and a given current (i.e. I²t higher than a nominal use of the fuse), the fuse will melt and break the arc.

The dimensions of the fuse can be chosen according to the application and in particular according to the time period during which it is acceptable for the electrical arcs to be maintained for a given current. In particular, it is possible to use a smaller fuse than if a fuse is put in series with the contactor (or pyrofuse), since no current passes through the fuse concerned here when the contactor is in the closed position. One thus obtains protection from maintaining of the electrical arcs, with a low impact on the total mass and on the overall dimensions.

The upper arc guide therefore here comprises two separate parts connected through the fuse.

For information purposes, it was observed that the use of an upper arc guide and of a lower arc guide can make it possible, by the configuration of the arc guides, to displace the electrical arcs from the contact area to the breaking area by extending the arc, for example before it reaches the fins if there are any. The extension of the arc can be a first breaking step in that it gradually reduces the current. For example, the use of an upper arc guide and a lower arc guide makes it possible to better control the displacement of the arc.

According to a particular embodiment, the upper arc guide comprises a plurality of fuses electrically connected between the first portion and the second portion of the upper arc guide.

It is therefore possible to use a circuit with several fuses, or a single fuse. If several fuses are used, they may be series- and/or parallel-connected between the two portions of arc guide.

According to a particular embodiment, the upper arc guide comprises a fuse holder to receive said fuse by connection, or several holders to receive each fuse of the plurality of fuses if the upper arc guide comprises a plurality of fuses.

The fuse can therefore be a discrete component, which then connects to a fuse holder.

According to a particular embodiment, the contactor is configured to receive a nominal direct current of amperage I, and in which the fuse/plurality of fuses is configured to fuse on receiving a current 10 times greater than I for a time period longer than 50 ms, or for a time period longer than 10 ms.

Typically, for I equal to 400 A, the fuse can be configured to fuse by receiving a current greater than 4000 A for a time longer than 50 ms, or even for a time longer than 10 ms.

According to a particular embodiment, the fuse/plurality of fuses is configured not to fuse on receiving a current in the order of I for a time period less than or equal to 10 ms.

A current in the order of I will for example be contained in a range of more or less 10% around the value of I.

In fact, the upper arc guide will allow the passage of currents resulting from arcs which themselves result from the passage of the nominal current. This does not require a fuse that enters into fusion at this stage.

With this embodiment fuses of small bulk and low weight can be used.

Note that if a fuse were used in series with the contactor, this fuse could for example have to accept a constant current of 400 A, and this fuse would be much more bulky than the fuse used here which is only crossed by a current during the appearance of arcs for a time period for example shorter than 10 milliseconds and for a current of 400 A.

In fact, a fuse capable of constantly accepting 400 A can accept, for example, 500 A for 10 seconds, or else 5000 A for 0.1 seconds (this gives (500 A)²×10 s=(5000 A)²×0.1 s).

If a fuse is used that can accept 400 A for 10 ms and for example a constant rating reached at 1000 s, this gives: (400 A)²*0.01 s=(12.7 A)²*1000 s. In other words, a fuse that can accept 400 A for 10 ms can accept a constant 12.7 A. But, since a 400 A, 1000V fuse has dimensions of approximately 135 mm*52 mm*73 mm for 500 grams, and a 10 A, 1000V fuse is 38 mm in length and 10 mm in diameter for 10 grams, the (approximately) 10 A fuse will be much less bulky and less heavy.

The invention also makes provision for an electrical energy distribution system comprising a high-voltage direct current source (for example delivering a direct nominal current of amperage I), a contactor as defined above having a first electrical contact connected to the high-voltage direct current source and a second electrical contact connected to a terminal of the system for the connection of a load.

The invention also makes provision for an aircraft comprising an electrical energy distribution system as defined above.

### BRIEF DESCRIPTION OF THE DRAWINGS

Other features and advantages of this invention will become apparent from the description below, with reference to the appended drawings which illustrate an exemplary embodiment thereof without any limitation. In the figures:

FIG. 1, already described, schematically illustrates a contactor of the prior art in the closed position.

FIG. 2, already described, schematically illustrates the contactor of FIG. 1 in the open position.

FIG. 3, already described, shows the displacement of the electrical arcs after the opening visible on FIG. 2.

FIG. 4, already described, shows the displacement of the electrical arcs after the first displacement visible on FIG. 3.

FIG. 5, already described, shows the passage of the current through the upper arc guide.

FIG. 6 shows a contactor according to an embodiment.

FIG. 7 is a graph showing the fusing of the fuses used in the contactor of FIG. 6.

FIG. 8 shows an electrical distribution system according to an embodiment included in an aircraft.

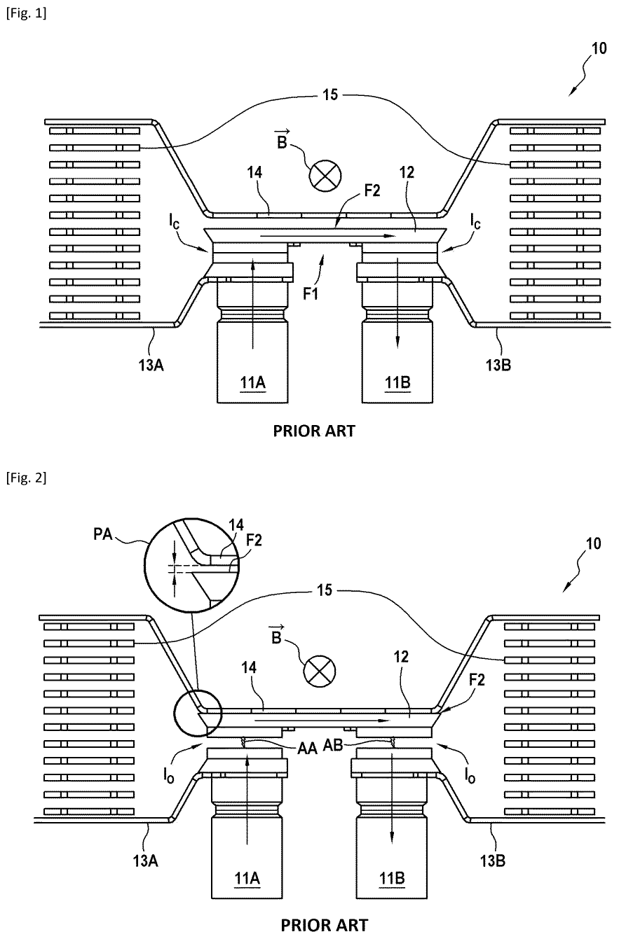

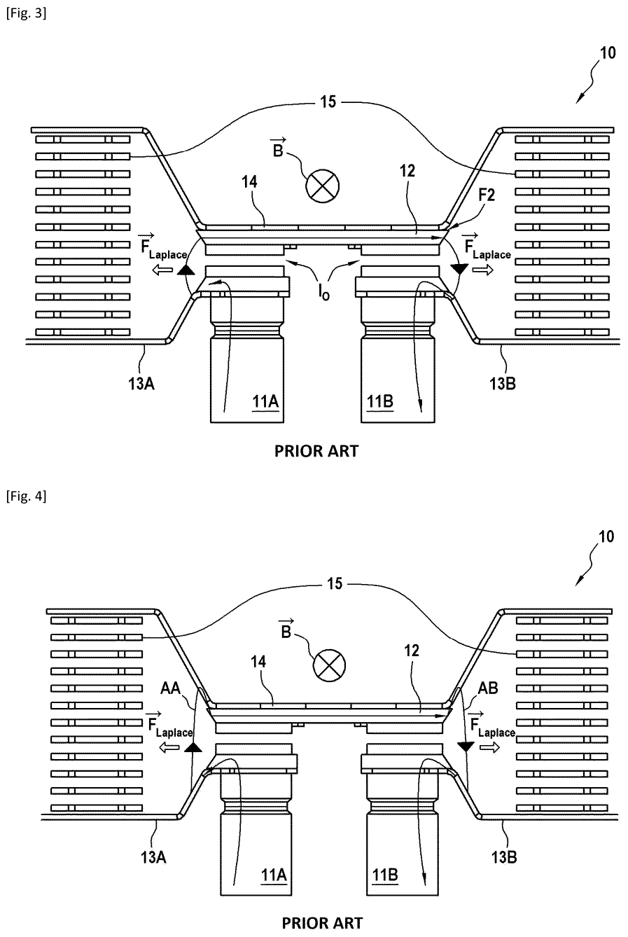

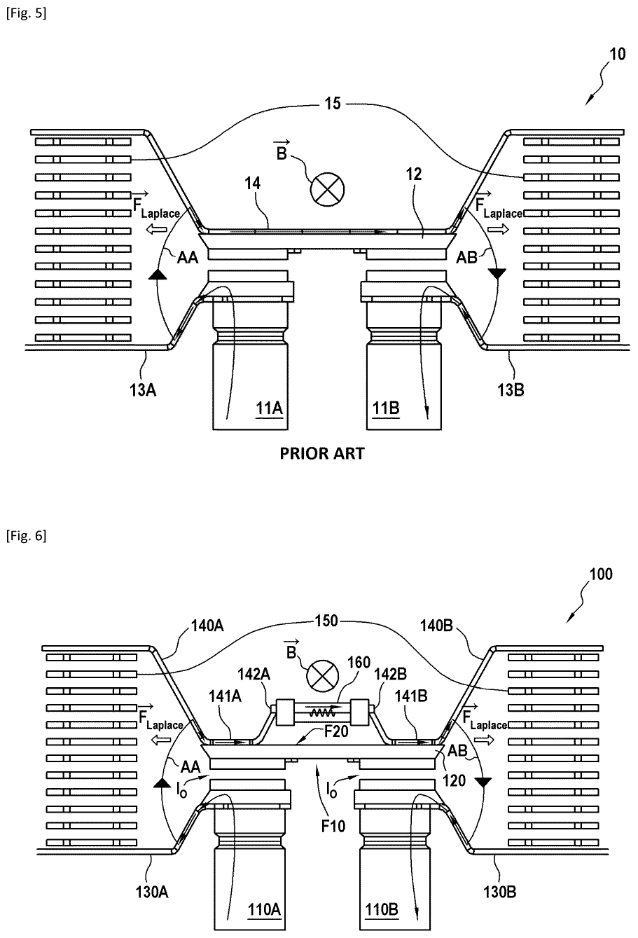

### DESCRIPTION OF THE EMBODIMENTS

A description will now follow of a contactor equipped with a fuse, according to an embodiment.

FIG. 6 is a schematic section view of a contactor. This contactor includes a first electrical contact 110A, a second electrical contact 110B, and a movable bridge 120.

On the figure, the movable bridge 120 is in the open position. Its lower face F10 is spaced apart from the two electrical contacts 110A and 110B, at the open interfaces IO. Hence, the current can only flow through the contactor of the first contact 110A toward the second contact 110B through the electrical arcs described hereinafter. The flow of the current is represented by bold arrows on the figure.

The contactor further includes a lower arc guide, comprising a first portion 130A connected to the first electrical contact 110A, which extends in the direction opposite the second electrical contact with respect to the first electrical contact. The lower arc guide further comprises a second portion 130B connected to the second electrical contact 110B, which extends in the opposite direction to the first electrical contact with respect to the second electrical contact. The lower arc guide extends in the lower portion of the contactor, delimited by the movable bridge (as is visible on the figure, below the movable bridge, the lower portion can be seen, and above the movable bridge, the upper portion can be seen).

On the side of the upper face F20 of the movable bridge, which is opposite the face F10, in the upper position of the contactor, an upper arc guide is arranged. This upper arc guide includes a first portion140A which faces the first portion of the lower arc guide 130A, the term “facing” being understood to mean that an electrical arc can be formed between these two arc guides, although they are inclined with respect to one another. The upper arc guide includes a second portion 140B which faces the second portion 130B of the lower arc guide.

The first portion 140A further includes a sub-portion 141A which is parallel and facing the upper face F20 (it is spaced apart from this face), and the second portion 140B also includes a sub-portion 141B which parallel and facing the upper face F20 (it is also spaced apart by this face).

The connection between the two portions 140A and 140B of the upper arc guide is done by means of a fuse 160. This fuse is connected to the portions 140A and 140B through a fuse holder made of two parts, a part 142A connected to the sub-portion 141A, and a part 142B connected to the sub-portion 141B.

At its lateral ends, between the upper arc guide and the lower arc guide, arc breaking fins 150 are arranged.

The lower arc guide and the upper arc guide have a shape configured so that the space between these arc guides increases when one moves away from the electrical contacts (for example this space increases from the first electrical contact 110A in the opposite direction to the second electrical contact 110B, and this space increases from the second electrical contact 110B in the opposite direction to the first electrical contact 110A).

Moreover, although this is not shown in the figure, the contactor includes permanent magnets generating a magnetic field \vec{B}, whose direction into the plane of the figure is symbolizing by a circled cross. This magnetic field \vec{B} causes the displacement of the electrical arcs toward the sides of the contactor, by means of the Laplace force (denoted \vec{F}_{Laplace} on the figure).

The figure shows the contactor in the open position, with an electrical arc AA formed between the first portion 130A of the lower arc guide and the first portion 140A of the upper arc guide, and an electrical arc AB formed between the second portion 130B of the lower arc guide and the second portion 140B of the upper arc guide.

The two arcs have an existence which has been long enough for the current to flow through the upper arc guide, as shown on the figure.

And, as illustrated, the current, to pass from the first portion 140A of the arc guide to the second portion 140B of the arc guide, must pass through the fuse 160.

The dimensioning of the fuse can be done so that the fuse enters into fusion after a given time period, and for a given current.

For example, for a contactor configured to receive a nominal direct current of amperage I (for example 400 A), the fuse is configured to fuse by receiving a current 10 times greater than I for a time period longer than 50 ms, or for a time period longer than 10 ms, according to the application.

Also, the fuse can be configured to avoid entering into fusion by receiving a current in the order of I for a time period less than or equal to 10 ms.

Those skilled in the art will be able to dimension the fuse to check these conditions.

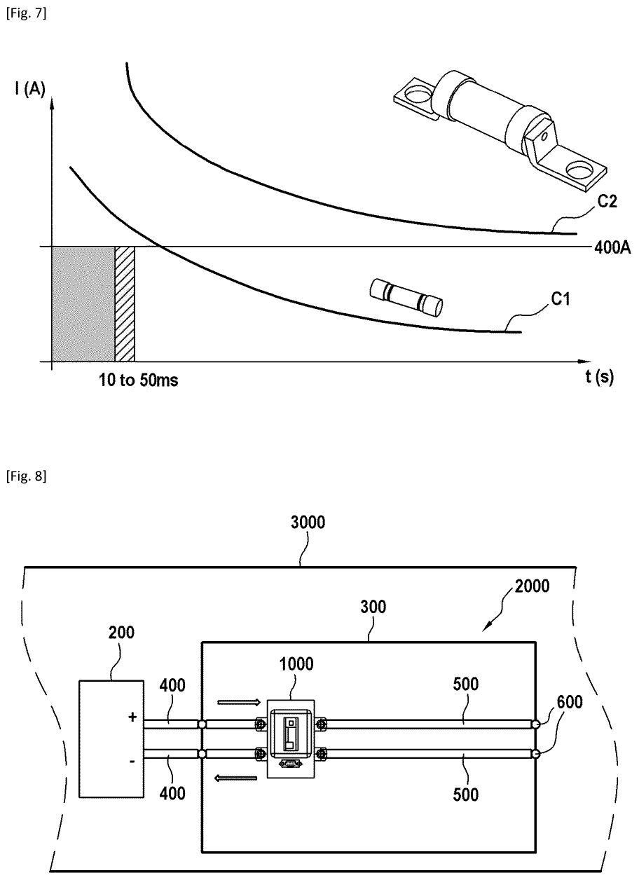

FIG. 7 is a graph showing the fuse curves (known as I² t curves) of two fuses that can be used for protecting a contactor.

More precisely, the curve C1 shows the fuse curve I² t of a fuse 160 that can be used in the contactor 100 described with reference to FIG. 6, capable of withstanding the passage of a current of 400 A for a time period slightly longer than 10 milliseconds without melting, but no longer than that.

On the other hand, if one were to use a fuse in series with the contactor to avoid the current peaks that appear upon the appearance of a short-circuit, one would use a fuse in accordance with the curve C2, still above the nominal 400 A, because it is still crossed by this current since it is in series with the contactor. A fuse in agreement with the curve C2 is bulkier and has more mass than a fuse in agreement with the curve C1 usable in the contactor according to the invention.

FIG. 8 schematically represents an electrical energy distribution system 2000 comprising a high-voltage direct current source 200, a distribution box 300, and cables 400 which connect the source 200 to the distribution box 300.

In the distribution box 300, for each phase, one has a contactor and here, the two contactors are in a contactor box 1000. The contactors can be those described with reference to FIG. 6.

The contactor is connected by busbars 500 to outputs 600 for the connection of an electrical load.

The figure partially represents an aircraft 3000 in which the system 2000 is used.

The embodiments described above make it possible to protect the contactors used in the aircraft, with an impact on the weight and the mass of the aircraft which is limited by comparison with other solutions in which a fuse is put in series with a contactor.

1. A contactor intended to be used in an electrical power distribution system within an aircraft and including a first electrical contact, a second electrical contact, and a movable bridge displaceable between a so-called closed position in which the movable bridge is in contact with the first electrical contact and the second electrical contact, and a so-called open position in which the movable bridge is spaced apart from the first electrical contact and from the second electrical contact, the movable bridge having a first face intended to be in contact with the first electrical contact and the second electrical contact in the closed position, and a second face opposite the first face,
the contactor further including:
a lower arc guide comprising a first portion connected to the first electrical contact, extending in the opposite direction to the second electrical contact with respect to the first electrical contact, and a second portion connected to the second electrical contact, extending in the direction opposite the first electrical contact with respect to the second electrical contact,
an upper arc guide located on the side of the second face of the movable bridge and comprising a first portion facing the first portion of the lower arc guide, a second portion facing the second portion of the lower arc guide, and a fuse connecting the first portion and the second portion of the upper arc guide.

2. The contactor as claimed in claim 1, wherein the upper arc guide comprises a plurality of fuses electrically connected between the first portion and the second portion of the upper arc guide.

3. The contactor as claimed in claim 1, wherein the upper arc guide comprises a fuse holder to receive said fuse by connection, or several holders to receive each fuse of the plurality of fuses if the upper arc guide comprises a plurality of fuses.

4. The contactor as claimed in claim 1, wherein the contactor is configured to receive a nominal direct current of amperage I, and wherein the fuse/plurality of fuses is configured to fuse on receiving a current 10 times greater than I for a time period longer than 50 ms, or for a time period longer than 10 ms.

5. The contactor as claimed in claim 4, wherein the fuse/plurality of fuses is configured not to fuse on receiving a current in the order of I for a time period less than or equal to 10 ms.

6. An electrical energy distribution system comprising a high-voltage direct current source, a contactor as claimed in claim 1, having a first electrical contact connected to the high-voltage direct current source and a second electrical contact connected to a terminal of the system for the connection of a load.

7. An aircraft comprising an electrical energy distribution system as claimed in claim 6.
